(19) United States
(12) Patent Application Publication
(10) Pub. No.: US 2013/0185670 A1
(43) Pub. Date: Jul. 18, 2013

(54) GRAPHICAL VIEW OF SOCIAL CONTENT STREAMS

(71) Applicants: Sean Liu, Sunnyvale, CA (US); Sabrina Chueh Ellis, Cupertino, CA (US)

(72) Inventors: Sean Liu, Sunnyvale, CA (US); Sabrina Chueh Ellis, Cupertino, CA (US)

(73) Assignee: GOOGLE INC., Mountain View, CA (US)

(21) Appl. No.: 13/349,361

(22) Filed: Jan. 12, 2012

(51) Int. Cl. G06F 3/048

(52) U.S. Cl. 715/781

(57) ABSTRACT

A system and machine-implemented method for displaying a list of entries for a social content stream is provided. A set of entries is obtained from at least one source associated with the social content stream. Information is extracted from each entry of the set of entries. A hierarchical order of the set of entries is determined based on the at least one of the user view count or the number of user hits. An arrangement of frames corresponding to the set of entries based on the determined hierarchical order is provided for display. The frames are displayable within a predefined area of a display on a user device. The size of each frame is based on the determined hierarchical order of the set of entries.

### BACKGROUND

The present disclosure generally relates to data streams, and, in particular, to providing a graphical format for presenting data from social content streams.

For web-based applications that return queried results, information is generally presented in list form that includes certain text and graphics. For example, streams from news feeds, entries on social networking web pages, and results of search queries are presented as linear top-to-bottom lists. Furthermore, typical lists allot each entry the same amount of space regardless of the content or characteristics of the content. Consequently, a user may not be able to differentiate one entry from another until the user begins reading the text of the entry. Thus, it may be desirable to implement a system for presenting entries from a stream of data in a graphical format.

### SUMMARY

The disclosed subject matter relates to a machine-implemented method for displaying a list of entries for a social content stream. A set of entries is obtained from at least one source associated with the social content stream. Information is extracted from each entry of the set of entries. A hierarchical order of the set of entries is determined based on the at least one of the user view count or the number of user hits. An arrangement of frames corresponding to the set of entries and based on the determined hierarchical order is provided for display. The frames are displayable within a predefined area of a display on a user device. The size of each frame is based on the determined hierarchical order of the set of entries.

The disclosed subject matter also relates to a machine-readable medium comprising instructions stored therein, which when executed by a system, cause the system to perform operations comprising displaying a list of entries for a social content stream. A search query for a social content stream is received from a remote device to initiate a search for a set of entries. The set of entries is obtained from at least one source associated with the social content stream. Information is extracted from each entry of the set of entries. The extracted information includes at least one of a user view count or a number of user hits. A hierarchical order of the set of entries is determined based on the at least one of the user view count or the number of user hits. An arrangement of the tiles is provided for display within a predefined area of a display on a user device based on the determined hierarchical order.

The disclosed subject matter further relates to a system comprising one or more processors and a machine-readable medium comprising instructions stored therein, which when executed by the processors, cause the processors to display a list of entries for a social content stream is provided. An initiation command signal is received from a remote device. The initiation command signal initiates the retrieval of several social content entries to populate an information feed. The several entries are obtained from at least one source associated with the social content stream. Information is extracted from each entry of the several entries. The extracted information includes at least one of a user view count or a number of user hits. A hierarchical order of the several entries is determined based on the at least one of the user view count or the number of user hits. The information feed is populated with the several entries. The several entries are arranged based on the determined hierarchical order. The information feed is displayable as several frames on a predefined area of a display on a user device. The size of each frame is based on the determined hierarchical order of the several entries.

According to various aspects of the subject technology, a system comprising one or more processors and a machine-readable medium comprising instructions stored therein, which when executed by the processors, cause the processors to display a list of entries for a social content stream is provided. A search query for a social content stream is received from a remote device to initiate a search for a set of entries. The set of entries is obtained from at least one source associated with the social content stream. Information is extracted from each entry of the set of entries. The extracted information includes at least one of a user view count or a number of user hits. A hierarchical order of the set of entries is determined based on the at least one of the user view count or the number of user hits. An arrangement of tiles corresponding to the set of entries is provided for display within a predefined area of a display on a user device. The tiles are arranged based on the determined hierarchical order.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment which provides for displaying a list of entries.

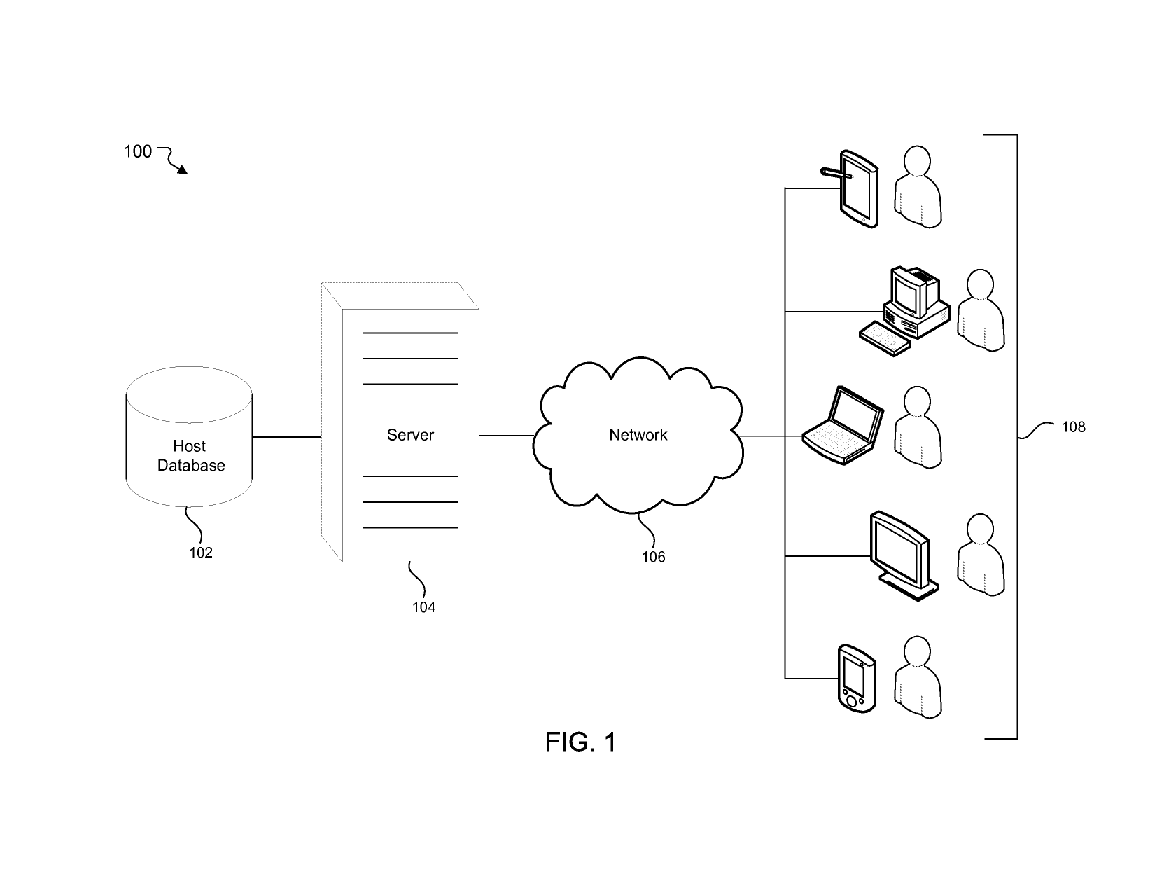

FIG. 2 illustrates an example of a server system for organizing and displaying a retrieved list of entries.

FIG. 3 illustrates an example method for providing for display a list of entries.

FIG. 4 provides a graphical representation of an example arrangement of the list of entries provided for display.

FIG. 5 conceptually illustrates an example electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The disclosed subject matter describes systems and techniques for displaying a list of entries in a graphical format for a social content stream. Social content streams provide for the exchange of user-generated content and interactive dialogue through web-based and mobile applications. A set of entries is obtained from at least one source, and information associated with each entry of the set of entries may be extracted. A hierarchical order of the set of entries may be determined based on the extracted information. The set of entries may be arranged based on the determined hierarchical order and provided for display.

A user submits a query from a client device. The query may be submitted via a search engine or by browsing a web page that includes a feed of data. A set of entries may be obtained from the one or more host databases based on the submitted query. Information associated with the set of entries may also be extracted from the one or more host databases. The extracted information may be utilized to determine a hierarchical order from which the set of entries is arranged and displayed.

Network environment 100 comprises one or more host databases 102 (e.g., computer-readable storage devices) for storing a variety of information on which a query may be performed. The network environment 100 further comprises one or more servers 104. Server 104 may receive queries from users operating client devices 108. Server 104 and client devices 108 may be communicatively coupled through a network 106. In some implementations, client devices 108 may request a list of entries via a submitted query. Upon receiving the query, server 104 may retrieve a set of entries from host database 102. Server 104 may additionally extract information from each entry of the entries and determine a hierarchical order for the set of entries based on the extracted information. Server 104 may provide for the display of the set of entries arranged based on the determined hierarchical order.

Each of client devices 108 can represent various forms of processing devices. Example processing devices can include a desktop computer, a laptop computer, a handheld computer, a television with one or more processors attached or coupled thereto, a personal digital assistant (PDA), a cellular telephone, a network appliance, a camera, a smart phone, an enhanced general packet radio service (EGPRS) mobile phone, a media player, a navigation device, an email device, a game console, or a combination of any these data processing devices or other data processing devices.

In some aspects, client devices 108 may communicate wirelessly through a communication interface (not shown), which may include digital signal processing circuitry where necessary. The communication interface may provide for communications under various modes or protocols, such as Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. For example, the communication may occur through a radio-frequency transceiver (not shown). In addition, short-range communication may occur, such as using a Bluetooth, WiFi, or other such transceiver.

In some aspects, network environment 100 can be a distributed client/server system that spans one or more networks such as network 106. Network 106 can be a large computer network, such as a local area network (LAN), wide area network (WAN), the Internet, a cellular network, or a combination thereof connecting any number of mobile clients, fixed clients, and servers. In some aspects, each client (e.g., client devices 108) can communicate with servers 104 via a virtual private network (VPN), Secure Shell (SSH) tunnel, or other secure network connection. In some aspects, network 106 may further include a corporate network (e.g., intranet) and one or more wireless access points.

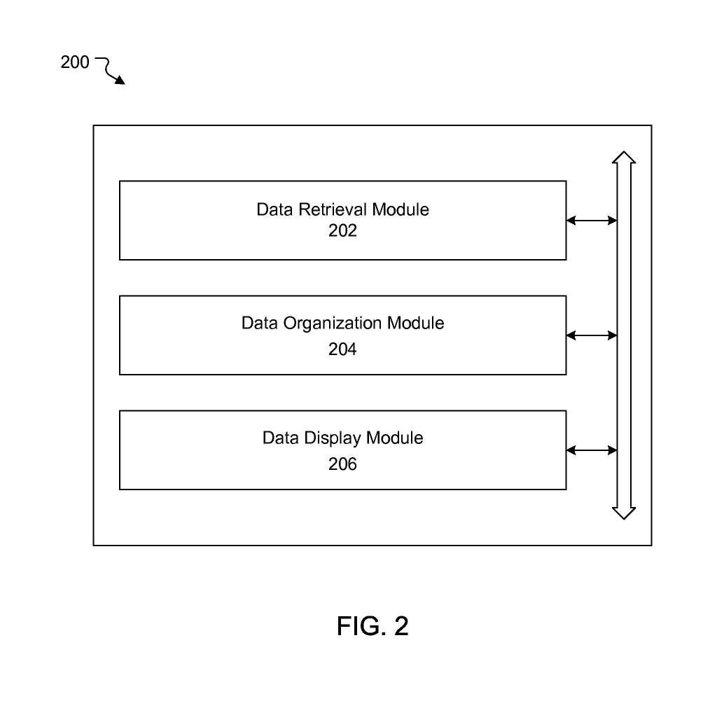

FIG. 2 illustrates an example of a system utilized for retrieving entries to be displayed in a graphical format. System 200 includes data retrieval module 202, data organization module 204, and data display module 206. These modules, which are in communication with one another, process information retrieved from host databases 102 to be displayed on client devices 108. For example, a set of entries to be displayed is obtained from the one or more host databases by data retrieval module 202. Data retrieval module 202 also extracts information associated with each entry. Data organization module 204 determines a hierarchical order of the set of entries based on the extracted information and arranges the set of entries based on the determined hierarchical order. Data display model 206 provides for display of the arranged set of entries to the client devices.

In some aspects, the modules may be implemented in software (e.g., subroutines and code). In some aspects, some or all of the modules may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both. Additional features and functions of these modules according to various aspects of the subject technology are further described in the present disclosure.

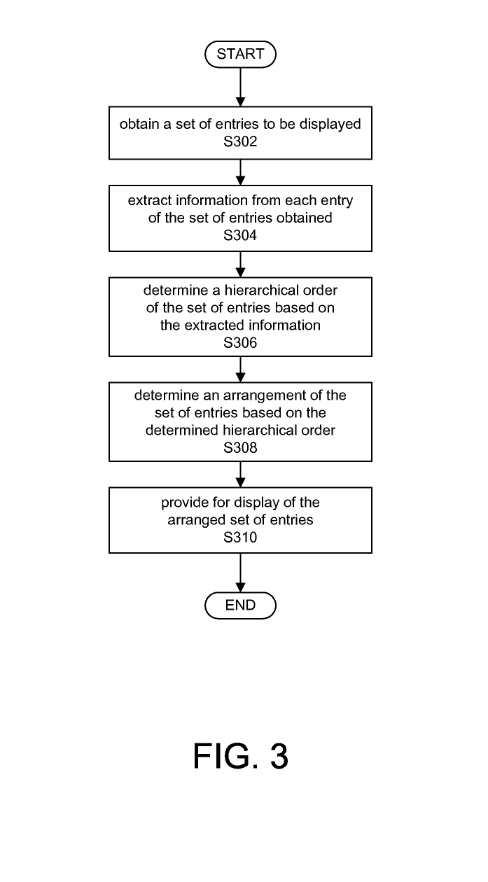

FIG. 3 illustrates example method 300 for providing for display of the arranged set of entries. A set of entries is obtained, according to S302. In some implementations, the set of entries may be obtained based on a user command. For example, a user may submit a query via a search engine, and the set of entries may be obtained as results to the submitted query. The user may also browse a web page that includes a feed of data, and the set of entries obtained may be used to populate the feed of data. For example, in the context of a social networking web page, the obtained set of entries may be used to populate a feed of textual, pictorial, and hyperlink posts made by users.

Information may be extracted from each entry of the set of entries, according to S304. The information extracted from the entries may provide metrics on which the organization of the set of entries may be based. The extracted information may include but is not limited to time stamps, user endorsements/ratings, hits/views, click-throughs, and prominence of author. Additionally, and particularly with social networking websites, the relationship between two users may be included in the extracted information. A hierarchical order of the set of entities may be determined based on the extracted information, according to S306. That is, the values of the extracted information may contribute to the determination of the hierarchical order.

For example, an entry that includes a time stamp with a more current time may result in the entry having a higher rank in the hierarchical order than an entry with a less current time stamp (i.e., a more current entry takes precedent to a less current entry). Likewise, entries with more user endorsements/greater user ratings, higher numbers of click-throughs, and authors of more prominence may also have higher ranks than entries with converse qualities. For example, user endorsements/user ratings may be increased by each additional user activating a button/icon on a webpage designated for endorsing a particular entry. Additionally, click-throughs (e.g., user hits) may be recorded as the number of instances where users activate a link embedded in a particular entry. Each click-through may also contribute to a view count, which is a cumulative total of a number of times a link has been viewed by users, whether the view has been directed from the particular link or from an alternate source (e.g., search engine links, direct links, etc.).

In some implementations, relationships between users in a social networking context may further be used to determine ranks in the hierarchical order. That is, on a social networking web page, users who are more closely related to one another may have higher ranks associated with their posts on each other's profiles than posts by less closely related users. The above examples are provided for illustrative purposes only, and are not intended to limit the scope of the invention. In fact, any combination of different information associated with the entries may be used to determine the hierarchical order the entries.

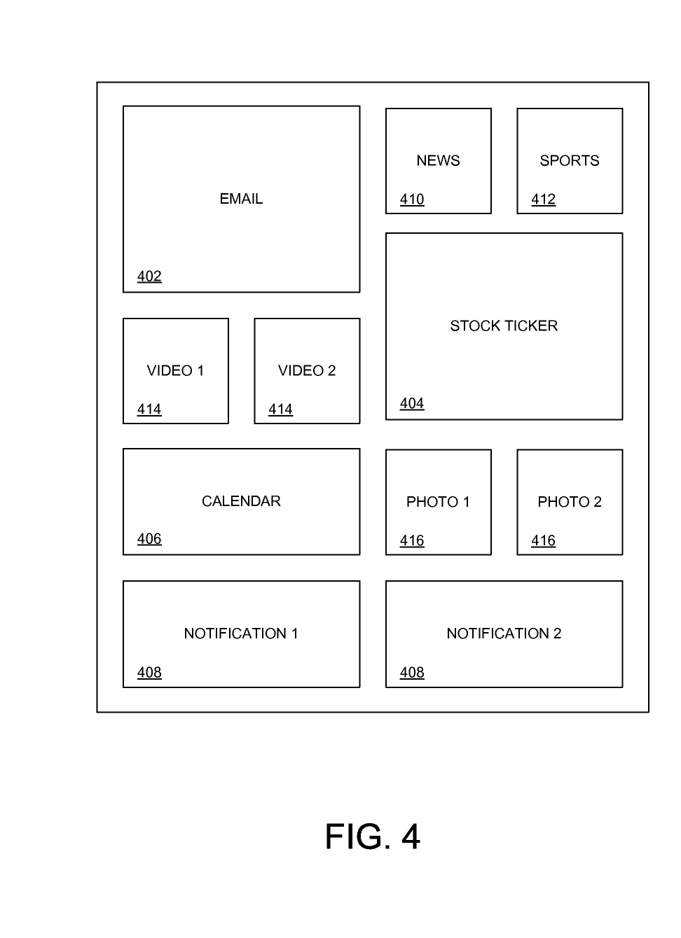

The set of entries may be arranged based on the hierarchical order, according to S308. Entries may be sorted from the highest rank to the lowest rank in the hierarchical order. For example, an entry with the most user endorsements or the highest number of click-throughs may have the highest rank while an entry with no user endorsements or click-throughs may have the lowest rank. The entries are arranged according to the rank in the hierarchical order. The arranged set of entries are provided for display, according to S310. The arrangement of the display is described in further details by reference to FIG. 4 below.

FIG. 4 provides a graphical representation of an example arrangement of the list of entries provided for display. Each entry is represented by a tile in the mosaic-type layout. Each entry also represents a type of content (e.g., stock ticker, news, sports, email, videos, pictures, calendar, etc.).While FIG. 4 depicts an arrangement of eight types of content, a variety of additional types of content may be presented in a variety of different arrangements. For example, the mosaic-type layout may include a larger number or a smaller number of tiles to cover the same area.

The list of entries are arranged in correspondence to a hierarchal rank associated with each tile (i.e., high ranking entries are displayed in the space of high ranking tiles). In some implementations, the rank of a tile may be determined based on the location of the tile. For example, tiles towards the top and left of the display may have the highest hierarchical rank. In one example layout, tiles in the upper left-hand corner of the display are the highest ranking tiles. Additionally and/or alternatively, the size of a tile may indicate the hierarchical rank of the tile (i.e., larger tiles have higher ranks) In some implementations, a combination of size and location may be used to indicate the prominence of an entry.

In FIG. 4, email tile 402 may provide an up-to-date email inbox to a user. Email tile 402, being the largest tile and having the top left position on the page, may correspond to a tile with the highest rank in the hierarchical order. As described above, the ranking may be determined by the information extracted from the entry. Stock ticker tile 404, which, in this example, is the same size as email tile 402, may correspond to a tile with the second highest rank only by virtue of its position being less prominent than that of email tile 402. Calendar tile 406 and notification tiles 408 may be the next three highest ranking tiles, respectively, if the determination of hierarchical order is biased in favor of the size of a tile. Alternatively, if the determination of hierarchical order is biased in favor of the position of a tile, then news tile 410 and sports tile 412 may be the next two highest ranked tiles, respectively, followed by video tiles 414, calendar tile 406 and photos tiles 416. In some implementations, the ranking of tiles may be determined based on a combination of size and location. Different fonts, colors, shading, or borders may also contribute to the determination of ranking of tiles.

The mosaic-type layout described above may be used to accommodate graphical representations of entries in addition to or in replacement of text. For example, if a user posts a comment on a social networking website, the user's profile picture may be displayed in the tile along with the comment. Furthermore, if the comment posted by the user includes a hyperlink (e.g. to a news article), a picture associated with the hyperlink may be displayed in the corresponding tile. Different combinations of text and graphics may be used in each tile.

In some implementations, a user may define the amount of graphics the user would like to have appear on a particular web page (e.g., the user's profile in a social networking web page). For example, the user may choose to have all tiles include only pictorial representations or include only textual representations. The user defined amount may alter the metric on which the hierarchical order is based. That is, if the user chooses to have only pictorial representations, then text entries will be assigned the lowest hierarchical ranks Conversely, if the user chooses to have only textual representations, then pictorial entries will be assigned the lowest hierarchical ranks Thus, user preferences may be accommodated by adjusting the way entries are ranked.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

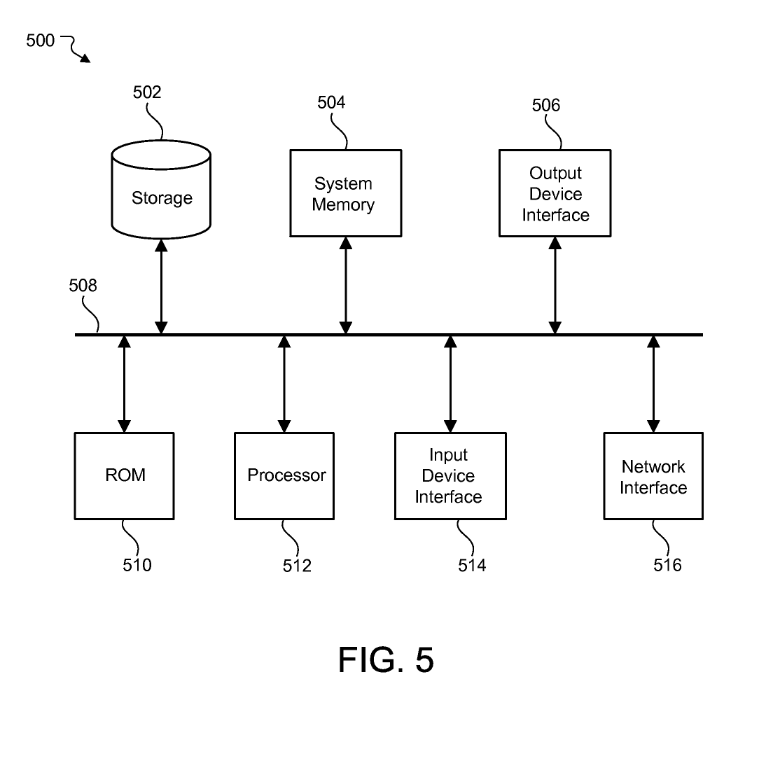

FIG. 5 conceptually illustrates an example electronic system with which some implementations of the subject technology are implemented. Electronic system 500 can be a computer, phone, PDA, or any other sort of electronic device. Such an electronic system includes various types of computer readable media and interfaces for various other types of computer readable media. Electronic system 500 includes a bus 508, processing unit(s) 512, a system memory 504, a read-only memory (ROM) 510, a permanent storage device 502, an input device interface 514, an output device interface 506, and a network interface 516.

Bus 508 collectively represents all system, peripheral, and chipset buses that communicatively connect the numerous internal devices of electronic system 500. For instance, bus 508 communicatively connects processing unit(s) 512 with ROM 510, system memory 504, and permanent storage device 502.

From these various memory units, processing unit(s) 512 retrieves instructions to execute and data to process in order to execute the processes of the subject disclosure. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off. Some implementations of the subject disclosure use a mass-storage device (such as a magnetic or optical disk and its corresponding disk drive) as permanent storage device 502.

Other implementations use a removable storage device (such as a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such as random access memory. System memory 504 stores some of the instructions and data that the processor needs at runtime. In some implementations, the processes of the subject disclosure are stored in system memory 504, permanent storage device 502, and/or ROM 510. For example, the various memory units include instructions for displaying a list of entries in a graphical format in accordance with some implementations. From these various memory units, processing unit(s) 512 retrieves instructions to execute and data to process in order to execute the processes of some implementations.

Bus 508 also connects to input and output device interfaces 514 and 506. Input device interface 514 enables the user to communicate information and select commands to the electronic system. Input devices used with input device interface 514 include, for example, alphanumeric keyboards and pointing devices (also called “cursor control devices”). Output device interface 506 enables, for example, the display of images generated by the electronic system 500. Output devices used with output device interface 506 include, for example, printers and display devices, such as cathode ray tubes (CRT) or liquid crystal displays (LCD). Some implementations include devices such as a touchscreen that functions as both input and output devices.

Finally, as shown in FIG. 5, bus 508 also couples electronic system 500 to a network (not shown) through a network interface 516. In this manner, the computer can be a part of a network of computers (such as a local area network (“LAN”), a wide area network (“WAN”), or an Intranet, or a network of networks, such as the Internet. Any or all components of electronic system 500 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims.

What is claimed is:

1. A method of providing for display of a set of entries for a social content stream executing on one or more computing devices, said method comprising:
obtaining, at the one or more computing devices, a set of entries from at least one source associated with the social content stream;
extracting information from each entry of the set of entries;
determining, using the one or more computing devices, a hierarchical order of the set of entries based on the at least one of the user view count or the number of user hits; and
providing for display of an arrangement of frames corresponding to the set of entries based on the determined hierarchical order, the frames being displayable within a predefined area of a display on a user interface, wherein a size of each frame is based on the determined hierarchical order of the set of entries.

2. The method of claim 1, wherein the extracted information comprises at least one of a user view count, a number of user hits, a user rating, or a time stamp.

3. The method of claim 1, wherein a location of each frame within the predefined area of the display is based on the determined hierarchical order of the set of entries.

4. The method of claim 1, wherein each entry of the set of entries represents one of a plurality of types of graphical content.

5. The method of claim 4, wherein the plurality of types of graphical content comprise a stock ticker, a news feed, a scoreboard, an email account, a video feed, a picture album, a calendar, and a notification window.

6. The method of claim 5, wherein each entry of the set of entries further includes text related to a corresponding graphical content of the entry.

7. The method of claim 1, further comprising filtering the set of entries based on the information extracted from each entry of the set of entries, wherein filtering the set of entries comprises removing entries from the set of entries.

8. The method of claim 7, wherein the filtering the set of entries is further based on a predetermined set of preferences, the predetermined set of preferences comprising a user determined percentage of graphical content to be included in the arrangement of the set of entries.

9. A machine-readable medium comprising instructions stored therein, which when executed by a system, cause the system to perform operations comprising:
receiving a search query for a social content stream from a remote device for initiating a search for a set of entries;
obtaining the set of entries from at least one source associated with the social content stream;
extracting information from each entry of the set of entries, the extracted information comprising at least one of a user view count or a number of user hits;
determining a hierarchical order of the set of entries based on the at least one of the user view count or the number of user hits; and
providing for display of an arrangement of the tiles within a predefined area of a display on a user device based on the determined hierarchical order.

10. The machine-readable medium of claim 9, wherein the extracted information further comprises a user rating and a time stamp.

11. The machine-readable medium of claim 9, wherein the determining the hierarchical order is based on a combination of values for each different extracted information.

12. The machine-readable medium of claim 9, wherein at least one of a size of each tile or a location of each tile provided for display in the arrangement is based on the determined hierarchical order of the set of entries.

13. The machine-readable medium of claim 12, wherein the size of each tile on the predefined area of the display is based on the determined hierarchical order of the set of entries, wherein an entry with a higher rank in the determined hierarchical order is displayable in a larger tile on the predefined area of the display than an entry with a lower rank in the determined hierarchical order.

14. The machine-readable medium of claim 12, wherein the location of each tile on the predefined area of the display is based on the determined hierarchical order of the set of entries, wherein an entry with a higher rank in the determined hierarchical order is displayable higher on the predefined area of the display than an entry with a lower rank in the determined hierarchical order.

15. The machine-readable medium of claim 9, further comprising:
receiving a predetermined set of preferences relating to the extracted information associated with each entry, and
filtering the set of entries based on the predetermined set of preferences, wherein the filtering of the set of entries comprises removing entries from the set of entries based on the predetermined set of preferences.

16. The machine-readable medium of claim 9, further comprising receiving a value for a percentage of the predefined area of the display in which to display graphical images, wherein the determining the arrangement of the set of entries as tiles comprises determining the number of graphical images to include in the arrangement.

17. A system for providing for display of a set of entries for a social content stream, the system comprising:
one or more processors; and
a machine-readable medium comprising instructions stored therein, which when executed by the processors, cause the processors to perform operations comprising:
receiving an initiation command signal from a remote device, the initiation command signal for initiating the retrieval of a plurality of social content entries to populate an information feed;
obtaining, at the one or more processors, the plurality of entries from at least one source associated with the social content stream;
extracting information from each entry of the plurality of entries, the extracted information comprising at least one of a user view count or a number of user hits;
determining, using the one or more processors, a hierarchical order of the plurality of entries based on the at least one of the user view count or the number of user hits;
populating the information feed with the plurality of entries, the arrangement of the plurality of entries being based on the determined hierarchical order; and
providing for display of the information feed as a plurality of frames on a predefined area of a display on a user device, wherein a size of each frame is based on the determined hierarchical order of the plurality of entries.

18. The system of claim 17, wherein a location of each frame is determined based on the determined hierarchical order of the plurality of entries.

19. The system of claim 17, wherein the information extracted from each entry further comprises a user rating and a time stamp.

20. The system of claim 19, wherein a location of each frame within the predefined area of the display is based on the determined hierarchical order of the plurality of entries.

21. A system for providing for display of a set of entries for a social content stream, the system comprising:
one or more processors; and
a machine-readable medium comprising instructions stored therein, which when executed by the processors, cause the processors to perform operations comprising:
receiving a search query for a social content stream from a remote device for initiating a search for a set of entries;
obtaining the set of entries from at least one source associated with the social content stream;
extracting information from each entry of the set of entries, the extracted information comprising at least one of a user view count or a number of user hits;
determining a hierarchical order of the set of entries based on the at least one of the user view count or the number of user hits; and
providing for display of an arrangement of tiles corresponding to the set of entries within a predefined area of a display on a user device, the arrangement of the tiles being based on the determined hierarchical order.

22. The system of claim 21, wherein at least one of a size of each tile or a location of each tile provided for display in the arrangement is based on the determined hierarchical order of the set of entries.

23. The system of claim 22, wherein the size of each tile on the predefined area of the display based on the determined hierarchical order of the set of entries, wherein an entry with a higher rank in the determined hierarchical order is displayable in a larger tile on the predefined area of the display than an entry with a lower rank in the determined hierarchical order.

24. The system of claim 22, wherein the location of each tile on the predefined area of the display based on the determined hierarchical order of the set of entries, wherein an entry with a higher rank in the determined hierarchical order is displayable higher on the predefined area of the display than an entry with a lower rank in the determined hierarchical order.
